(19) United States
(12) Patent Application Publication
(10) Pub. No.: US 2016/0159216 A1
(43) Pub. Date: Jun. 9, 2016

(54) Haptic Motor-Vehicle Accelerator Pedal having an Elastically Coupled Actuator and Method and Control Unit for Controlling said Accelerator Pedal

(71) Applicant: ROBERT BOSCH GMBH, Stuttgart (DE)

(72) Inventors: Ulrich Konigorski, Bruchsal (DE); Radoy Stanchev, Darmstadt (DE); Udo Sieber, Bietigheim (DE)

(21) Appl. No.: 14/907,025

(22) PCT Filed: Jun. 4, 2014
(86) PCT No.: PCT/EP2014/061584

§ 371 Date: Jan. 22, 2016

(30) Foreign Application Priority Data
Jul. 23, 2013 (DE) 10 2013 214 371.0

(51) Int. Cl. B60K 26/02

(52) U.S. Cl. CPC B60K 26/021; B60K 2026/023

(57) ABSTRACT

A pedal system for a motor vehicle, such as an accelerator pedal system, includes an elastic coupling element, a control unit, a pedal lever, and an actuator. The elastic coupling element is operatively positioned between the pedal lever and the actuator, and has a relatively low stiffness. The control unit is configured to control the actuator. The elastic coupling element is configured to damp brief force and/or torque fluctuations occurring in, for example, the actuator, such that said force and/or torque fluctuations are not transmitted to the pedal lever. A spring deflection of the elastic coupling element, in a direction of force applied to the pedal lever, operates as a control variable for controlling the actuator. A method relates to controlling such a haptic accelerator pedal and a correspondingly configured control unit.

### FIELD OF THE INVENTION

The present invention concerns a pedal system for a motor vehicle and a method as well as a control unit for controlling such a pedal system in a motor vehicle. The invention further concerns a computer program product that is intended to implement the method according to the invention when executed on a programmable control unit, as well as a computer readable medium on which such a computer program product is stored.

### PRIOR ART

In modern motor vehicles a driver is frequently supported when driving the vehicle by a number of items of information that are made available. In particular, facilities for haptic feedback to the driver by means of an accelerator pedal of the vehicle are also implemented. The accelerator pedal is equipped for this purpose with an actuator that enables a pedal lever to be subjected to a force in a specific manner. Accelerator pedals equipped in this way are frequently referred to as haptic accelerator pedals.

For example, the actuator can oppose further depression of the accelerator pedal from a certain accelerator pedal position in order to signal to a driver for example that a stronger depression of the accelerator pedal would result in an excessive increase of the fuel consumption. Alternatively, a time varying force can be exerted on the accelerator pedal using the actuator in order to set the accelerator pedal oscillating, for example in the form of vibrations or pulsations.

DE 25 55 429 describes a system for producing tactile or haptically perceptible signals on a pedal in a vehicle.

DE 10 2013 205281 describes the basic mechanical design of a pedal system that is implemented to provide haptic feedback to a vehicle driver.

### DISCLOSURE OF THE INVENTION

Embodiments of the present invention enable a pedal system for a motor vehicle with improved control of the force exerted in the direction of a vehicle driver by means of a haptic accelerator pedal. Embodiments of the present invention further enable advantageous control of such a haptic accelerator pedal in a pedal system as well as a control unit adapted for the implementation of such a method.

According to a first aspect of the present invention, a pedal system for a motor vehicle is proposed that comprises a pedal lever that can be displaced by a driver by exerting a force, an actuator that is designed to exert a restoring force acting on the pedal lever in opposition to said force, as well as a control unit for controlling the actuator. The pedal system further comprises an elastic coupling element that is operatively disposed between the pedal lever and the actuator so that the opposing force produced by the actuator is at least partly transferred to the pedal lever by means of the coupling element. The pedal system is characterized in that a spring travel of the elastic coupling element in the direction of the force exerted on the pedal lever is used as a control variable for the control unit. In one embodiment the coupling element can have a relatively low stiffness, i.e. can comprise a spring constant that is lower than 15 Nm/° pedal angle.

As a result of a spring travel of the elastic coupling element being used as a control variable for controlling the force that the actuator exerts on the pedal lever, the control of the actuator or the force exerted by said actuator can be improved. Likewise, the control can take place more rapidly because a spring travel, which can be for example a length or elongation or a twist angle of the elastic coupling element, is directly used as a control variable. Hence in particular control is not carried out by means of possibly erroneous control variables, such as for example the drive energy of the actuator, because the drive energy can fluctuate owing to diverse factors or can be affected by a faulty measurement. If for example a direct current motor is used as an actuator and the drive current of said direct current motor is used as a control variable, the control can be inaccurate because the drive current can be influenced for example by the ambient temperature and possibly friction in the drive. In contrast to such indirect control, with the pedal system described above and below direct control is carried out with the spring travel of the elastic coupling element as a control variable. The actuator is thus controlled independently of friction, ambient temperature or other factors that influence the actuator in order to exert the desired force on the pedal lever in a repeatable manner with very high accuracy.

Embodiments of the accelerator pedal according to the invention can inter alia be viewed as based on the following considerations and findings:

Previous haptic accelerator pedal systems mainly comprise a directly coupled force drive or torque drive for generating an additional restoring force. Directly coupled force drive or torque drive means here that a transfer mechanism, for example in the form of a linkage and/or of a spur gear, between an actuator as a source of force or torque and the pedal lever of the accelerator pedal is made wholly or substantially rigid and thus behaves essentially inelastically. As a result, for example unavoidable brief dips in momentum of a direct current motor with brushes, which are also referred to as “torque-ripple”, are reproduced on the pedal lever substantially unchanged in their relative magnitude, which can sometimes be perceived by the driver as very distracting. The elastic coupling element as described above and below can be described in its action as a mechanical low pass filter, because said torque-ripple is not passed to the driver, or only to a reduced extent.

Moreover, the value of the additional restoring force to be applied by the actuator to the pedal lever can be affected in an uncontrolled manner. For one thing, for example in the event of a suitably rapid pedal lever operation, unwanted increases of the restoring force could occur because of additional moments of inertia as a result of the coupled accompanying movements of the actuator. On the other hand, the force or torque transfer mechanism for the actuator is generally affected by friction. However, the frictional behavior is regularly subject to different influences, for example temperature dependent influences, caused by batch variation or caused by ageing, and may therefore at best be predetermined approximately. Moreover, a force or torque relationship to the applied current through the actuator is subject to influences by temperature fluctuations, material fluctuations and component tolerance fluctuations, which are involved in determining the restoring force practically as unknowns.

Said shortcomings can be eliminated or reduced according to an idea underlying the invention by providing an elastic coupling element between the pedal lever and the actuator of the accelerator pedal, using which a suitable elasticity is introduced into the transfer mechanism, wherein the spring travel of the elastic coupling element is used as a control variable for the actuator, i.e. such that the actuator is driven or displaced according to the spring travel of the elastic coupling element in one of two displacement directions over a distance predetermined by the control unit with a speed also predetermined by the control unit.

Any component can be operatively provided for this purpose between the pedal lever and the actuator as an elastic coupling element that provides elastic coupling of said two components with a spring constant that is significantly lower than for the coupling that is conventionally assumed to be ideally rigid between the pedal lever and the actuator. In particular, the spring constant can be less than 15 Nm/° pedal angle, preferably less than 3 Nm/° pedal angle and more preferably in a range from 0.3 to 1 Nm/° pedal angle. The elastic coupling element can in particular be in the form of a spring, for example of a coil spring, because the elastic properties thereof can be accurately predetermined and can remain constant over a long period of time. The basic principle for this is that an elastic coupling element with lower stiffness, i.e. a lower spring constant, can better fulfil the function of a mechanical low pass filter than one with a higher stiffness, because said torque-ripple can be absorbed better and kept away from the pedal lever. An elastic coupling element with lower stiffness, for example a spring with a lower spring constant, can however require a greater extension in order to exert a predetermined force on the pedal lever. Said required greater extension can be achieved with a motor and a gearbox. In order to continue to achieve high accuracy in relation to the force exerted on the pedal lever, the spring travel of the elastic coupling element is especially used as the control variable for the actuator. Hence fast and accurate control of the actuator can be carried out, which can be a prerequisite for the use of an elastic coupling element with lower stiffness.

The elastic coupling element can in particular be designed to significantly damp oscillations produced by the actuator with frequencies of more than 8 Hz, preferably more than 15 Hz and more preferably in a range from 30 to 4000 Hz. The elastic coupling element can thus be used as a type of mechanical low-pass filter between the actuator and the pedal lever, so that on the one hand low frequency displacements can indeed be transferred from the actuator to the pedal lever by transferring forces or torques, in order for example to produce haptically perceptible signals at the pedal in a desired manner, but on the other hand for example unwanted high frequency force or torque fluctuations cannot be transferred from the actuator to the pedal lever by means of the elastic coupling element.

In order to be able to suitably activate the haptic accelerator pedal that is provided with an elastic coupling element and to be able to produce suitable haptically perceptible signals despite the elastically flexible coupling between the actuator and the pedal lever, it can be necessary to provide at least one pedal lever position sensor and an actuator position sensor at the accelerator pedal. The pedal lever position sensor is used to detect a current position of the pedal lever, whereas the actuator position sensor is used to detect a current position of the actuator.

Depending on the structural design of the components of the haptic accelerator pedal, for this a position of the pedal lever or of the actuator is understood to mean for example a spatial arrangement of the pedal lever or actuator relative to a reference position. The spatial arrangement can be defined for this as the distance to a reference point or as the angle difference from a reference position for example.

As described below in detail, it can further be necessary for controlling a force on the haptic accelerator pedal to provide information about the elastic properties of the elastic coupling element, for example in the form of characteristics that for example specify a deformation of the coupling element as a function of a force or torque exerted on the coupling element.

According to a second aspect of the present invention, a method for controlling the pedal system described above is proposed. For this it is assumed therefrom that the pedal lever of the accelerator pedal can be displaced within a displacement region along an actuation direction between a rest position φₚ₀ and a maximum activated position φₚₘₐₓ and can be stimulated by means of the actuator by exerting a counter force against the actuation direction for producing a haptically perceptible signal. The control method is characterized in that a current position φₚ of the pedal lever as well as a current position φₐ of the actuator are determined and the actuator is controlled based thereon such that the haptically perceptible signal is exerted on the accelerator pedal with a predetermined force profile by the actuator by means of the coupling element. When controlling the actuator, besides the determined current position φₚ of the pedal lever and the current position φₐ of the actuator, the elastic properties of the coupling element are also taken into account.

The position of the actuator can be controlled during this in an advantageous manner using control in two degrees of freedom.

According to a third aspect of the present invention, a control unit is described that is designed to regulate a haptic accelerator pedal in a pedal system and in doing so to carry out a method such as has been described above with reference to the second aspect of the invention.

For this purpose the control unit can comprise inter alia a data input for the reception of data indicative of a current position of the pedal lever, a data input for the reception of data indicative of a current position of the actuator as well as an optimal value controller and a PID controller.

The control unit can implement the proposed control method as well as any information analyses of sensor signals in hardware and/or in software. It can be advantageous to program a programmable control unit for implementation of the method described above. For this purpose, a computer program product can comprise computer-readable instructions that instruct the programmable control unit to carry out the steps of the respective method. The computer program product can be stored on a computer-readable medium, such as for example a CD, a DVD, a flash memory, a ROM, an EPROM or similar. In order to be able to correctly activate the arrangement to be taken up by the actuator, in addition to the processing of further sensor data, information that is stored in a database or in the form of characteristics, and that concerns for example the elastic properties of the coupling spring or a response behavior to certain control signals to be carried out by the actuator or a system response of the actuator can also be used.

The proposed operative interposition of an elastic coupling element between the pedal lever and the actuator that is subjecting the pedal lever to a force or to a torque can have the following advantages among others:
The introduced elasticity enables a low impedance and hence the decoupling of a disturbance of the control variable for the control method used to control the force on the haptic accelerator pedal.
A low spring stiffness or spring constant of the elastic coupling element can be compensated with a higher controller gain.
A low spring stiffness can have a positive effect on the control precision and hence the influence of for example static friction or transmission play can be taken into account better.
A type of advantageous “torque sensor” can be provided, wherein additional pedal forces can be controlled within tolerances.
A torque control can be reformulated as a position control that is simpler to manage and that eliminates the influences of temperature and friction on the exerted force or torque.

It is noted that possible features and advantages of embodiments of the invention are described herein partly with reference to a pedal system according to the invention, partly with reference to a method according to the invention and partly with reference to a control unit according to the invention. A person skilled in the art will recognize that the individual features can be combined or exchanged with each other in a suitable manner, for example can be transferred from the control unit to the method and vice-versa, in order to be able to achieve further embodiments and possible synergy effects in this way.

### BRIEF DESCRIPTION OF THE FIGURES

Embodiments of the invention are described below with reference to the accompanying figures. Neither the description nor the figures should be construed as limiting the invention.

FIG. 1 shows schematically a vehicle with a pedal system according to an embodiment of the present invention.

FIG. 2 shows a perspective view of a haptic accelerator pedal of a pedal system according to an embodiment of the present invention.

FIG. 3 shows another perspective view of the haptic accelerator pedal illustrated in FIG. 2.

FIG. 4 shows a control technology model of an actuator and a controller structure for carrying out a control method for a pedal system according to an embodiment of the present invention.

FIG. 5 shows an alternative illustration of a controller for a pedal system according to an embodiment of the present invention.

FIG. 6 shows an elastic coupling element for a pedal system according to a further embodiment of the invention.

FIG. 7 shows an elastic coupling element for a pedal system according to a further embodiment of the invention.

The figures are only schematic and are not to scale.

### EMBODIMENTS OF THE INVENTION

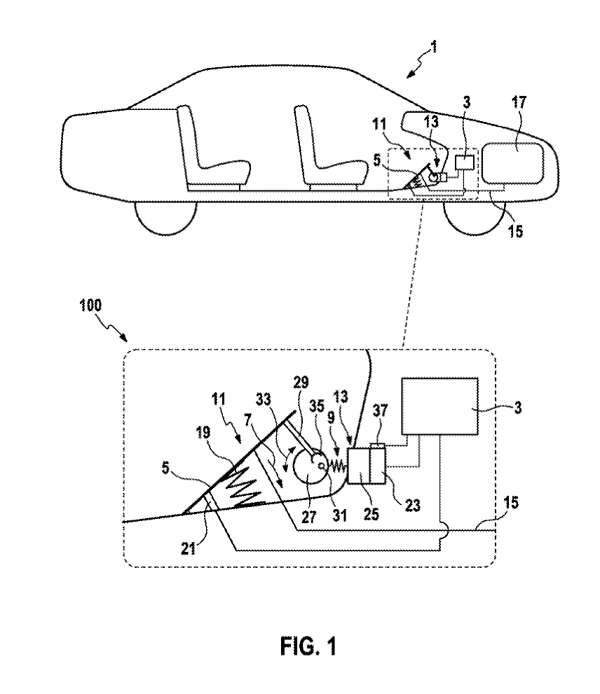

FIG. 1 shows a sectional view of a vehicle 1 with a haptic accelerator pedal 11 of a pedal system 100. By depressing the pedal lever 5, a driver can cause an engine 17 of the vehicle 1 to accelerate the vehicle by means of a cable 15 or a line connected to an engine control unit (not shown). For this purpose the driver must depress the pedal lever 5 in an actuation direction of the arrow 7, whereby the pedal lever 5, starting from a rest position, is caused to move along a displacement region to a maximally activated position. During this a pedal lever position sensor 21 can determine the current position or location of the pedal lever 5. A spring 19 biases the pedal lever 5 opposite to the actuation direction 7 towards the rest position.

The accelerator pedal 11 is embodied in the form of a haptic accelerator pedal. For this purpose, the accelerator pedal 11 comprises an actuator 13, using which the pedal lever 5 can be displaced in a desired direction opposite to the actuation direction 7 or can be acted upon in said direction by a force. The actuator 13 can hereby stimulate the pedal lever 5 to oscillate, for example in the form of vibrations or pulsations. Alternatively, the actuator 13 can exert a force on the pedal lever 5 that makes a further depression of the pedal lever 5 harder and hence can be perceived by a driver as a pressure point when operating the pedal lever 5.

The actuator 13 can be operated with a direct current motor 23 that is coupled by means of a gearbox 25 to an actuating element 27. By actuating the motor 23 the actuating element 27 can, as indicated by the arrow 33, be turned clockwise or anticlockwise or displaced in two opposite directions for example. A driving element 31, for example in the form of a cam, is provided on the actuating element 27. In the case of a circular actuating element 27 the driving element 31 can be disposed in an off-center region. Said driving element 31 can work in conjunction with a mechanical coupling element 29 provided on the pedal lever 5, which in one embodiment can be implemented for example as a force transfer element in the form of a tappet. For this purpose, the mechanical coupling element 29 comprises for example a linking element 35 on its end facing towards the actuator 13, which in one exemplary embodiment can be implemented as a forked socket, to which the driving element 31 can be mechanically coupled once the actuating element 27 has been moved into a suitable position.

Alternatively, the actuator can also be implemented as a direct drive, for example with a torquer motor, whereby high forces can also be produced without a gearbox.

The actuator 13 is activated by a control unit 3. The control unit 3 detects if a haptically perceivable signal is to be transmitted to a driver by means of the pedal lever 5, in order for example to notify the driver of the possibility of a fuel-saving driving manner or a hazard situation. The control unit thereupon controls the actuator such that a constant or time-varying force is exerted on the pedal lever 5 opposite to the actuation direction 7.

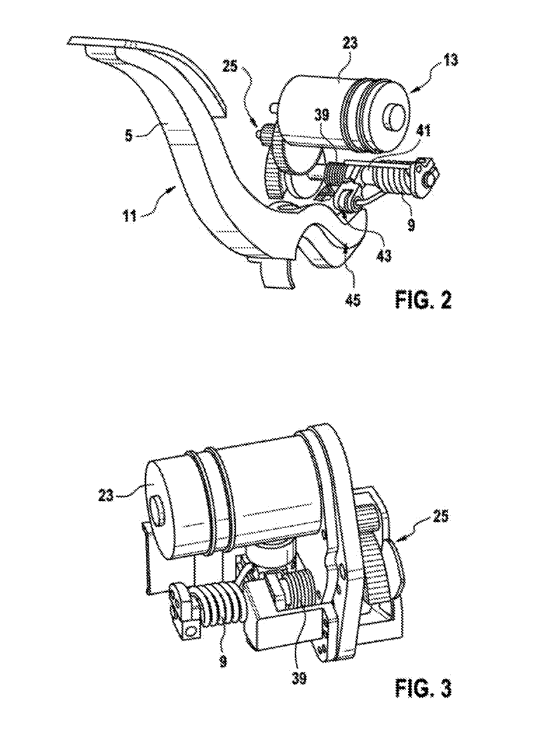

As schematically illustrated in the enlarged representation of FIG. 1, the actuator 13 is not rigidly coupled to the pedal lever 5. Instead, an elastic coupling element 9 in the form of a spring is provided between the gearbox 25 of the actuator 13 and the actuating element 27, so that the control forces effected by the actuator 13 are passed by means of said elastic coupling element 9 to the actuating element 27 and by means of the same to the pedal lever 5. Because of the elastically sprung properties of the coupling element 9, it can thus be substantially prevented that for example brief dips in momentum (torque-ripple) occurring in the motor 23 of the actuator 13 are passed directly to the pedal lever 5 and can be perceived as distracting there by a driver. Instead, such high frequency disturbances are significantly damped by the elastic coupling element 9.

Whereas in FIG. 1 the force transfer mechanism of an embodiment of a haptic accelerator pedal 11 is shown highly schematically, in FIGS. 2 and 3 two perspective views of a haptic accelerator pedal 11 are illustrated in a physical embodiment. The actuator 13 comprises here a direct current motor 23 with a downstream gearbox 25, by means of which the torque produced by the motor 23 is transferred to a shaft 41. In order to transfer the torque to the pedal lever 5 of the haptic accelerator pedal 11, however, said shaft 41 is not rigidly coupled to the pedal lever 5. Instead, an elastic coupling element 9 in the form of a coil spring is provided on the shaft 41, so that the torque engaging the shaft 41 is transferred in an elastically sprung manner to an actuating element in the form of a lever 43 that is connected to said elastic coupling element 9.

Said lever 43 transfers the torque to a mechanical coupling element in the form of a protrusion 45 of the pedal lever 5. As described in detail below, the actuator 13 can be suitably activated for this such that desired forces or patterns of forces, for example in the form of vibrations or pulsations, are transferred to the pedal lever 5, but unwanted high frequency oscillations are filtered out by the elastic coupling element 9 by damping. An additional actuator restoring spring 39 acts as a transmission bias and thus ensures noise and wear reduction.

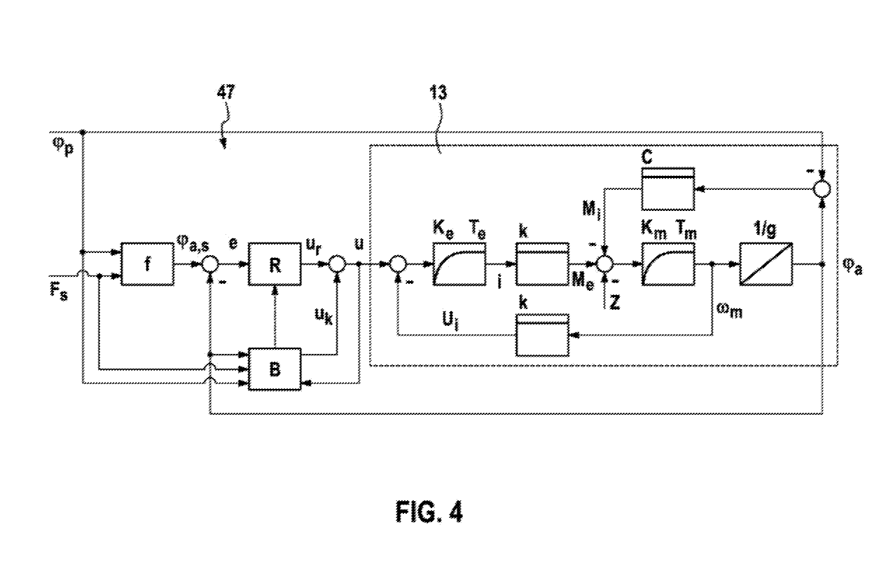

FIG. 4 shows a structural representation of the actuator 13 and a control function 47 in the control unit 3 that is provided to control the same. The actuator 13 is composed of a direct current motor, a gearbox and a coil spring as the elastic coupling element.

The actuator is controlled by means of an armature voltage (u) of the direct current motor and the position of the actuator, that is an angle at the output of the actuator gearbox φₐ, constitutes an output variable. The direct current motor can be viewed as being divided into an electrical and a mechanical sub system. Both sub systems are modelled as first order delay elements. For this a static gain (Kₑ) and a time constant (Tₑ) of the electrical sub system are dependent on an electrical resistance and an inductance of armature windings. Parameters of the mechanical sub system (Kₘ, Tₘ) are determined by a rotational inertia of the motor armature and a speed-proportional friction component. The motor armature is accelerated by an electromagnetic drive torque (Mₑ), which is proportional to the armature current (i) via a motor constant (k), minus a load torque (M₁) and a disturbance torque (z). An angular rotation rate of the motor armature (ωₘ) is an output of the mechanical sub system. Owing to a displacement of an armature conductor in the magnetic air gap field, a voltage (U₁) is induced that constitutes a reaction of the mechanical sub system to the electrical sub system. The gearbox downstream of the engine is modelled by a constant transmission ratio (g).

The force applied to the pedal lever 5 by the actuator 13 depends on a motor load torque via the angle-dependent transmission ratio between the actuator and the pedal lever. For this reason the control of the additional restoring force is implemented by means of the control of the motor load torque. The motor load torque is given by the product of the spring stiffness (C) of the elastic coupling element and the difference of the pedal and actuator angles (φₚ−φₐ). Because the pedal angle φₚ is predetermined by the driver and a characteristic of the spring stiffness is assumed to be invariant, the load torque can only be adjusted by means of the actuator angle φₐ. The control of the load torque is thus implemented by position control of the actuator angle. During this a torque sensor is simulated by means of measurement of the pedal angle and the actuator angle as well as knowledge of the spring stiffness.

If alternatively the load torque is measured directly, then the influences to which the spring stiffness is subject do not need to be taken into account in the modelling and the controller design.

The linear actuator model does not contain the influence of non-linear friction components, which is modelled as an unknown disturbance variable (z). In the observation function (B) said disturbance variable is estimated in addition to the system states and is used for disturbance variable compensation (uₖ).

A controller (R) that can be in the form of a PID algorithm for example receives as an input a deviation (e) between target and actual actuator angles (φ_{a, s}−φₐ). Alternatively, a state controller can be used that uses the system states estimated by the observation function. If there is additionally a current measurement, the same can be used for the employment of a reduced observation function or a cascade control arrangement.

In the block (f) the target actuator angle (φ_{a, s}) is calculated from the pedal angle (φₚ) and the desired additional restoring force (Fₛ). The transmission ratio between the actuator and pedal levers, which is dependent on the pedal angle (φₚ), is taken into account during said calculation.

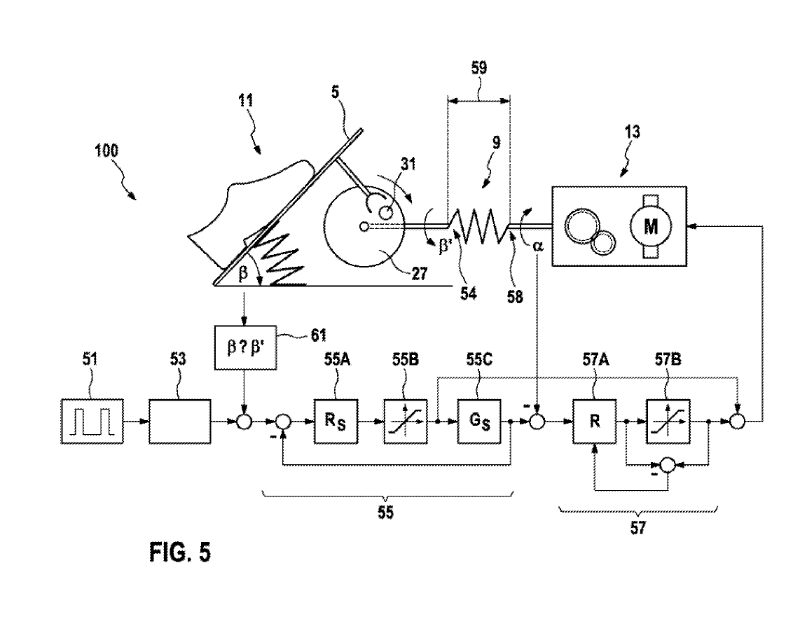

In FIG. 5 a structure of a control circuit, such as can be implemented in a control unit 3 for the control of a pedal system 100 according to an embodiment of the present invention, is illustrated in an alternative way.

A force profile, which can be plotted either against time or against the pedal angle, is used as an input variable 51 and is illustrated as an additional restoring force that is intended to act on the pedal lever 5 by means of the coupling spring 9. Said force profile 51 is converted into a spring travel/angle of the elastic coupling element 9 based on the known elastic properties, in particular the spring stiffness, of the elastic coupling element 9, wherein the spring travel/angle causes or determines the additional restoring force owing to the spring stiffness of the elastic coupling element 9.

The known elastic properties of the elastic coupling element 9 are offset against the force profile in the offset module 53, so that the offset module 53 provides the control variable for the spring travel or the spring angle as its output value, wherein said control variable defines the target value for the position variation of the elastic coupling element 9.

The elastic coupling element 9 comprises a suspension point 58 on the gearbox side and a suspension point 54 on the pedal side. The position or a relative twist angle of the suspension points 54, 58 to each other defines the spring travel/angle of the elastic coupling element 9. The suspension point 54 on the pedal side can also be referred to as the foot point β′. The angular position of the suspension point 54 on the pedal side of the coupling spring acting as the elastic coupling element 9 depends only on a pedal opening angle β. The calculated spring travel/angle, which arises from the target force profile, is added to the angular position of the suspension point 54 on the pedal side that is thus correlated with the pedal opening angle β. The result is a target position of the actuator or of the gearbox output thereof at the suspension point 58 of the elastic coupling element 9 on the gearbox side.

The position sensor unit 61 is implemented to determine a position or angular position of the pedal opening angle β as well as of the foot point β′ of the suspension point 58 on the pedal side and to feed the same to the control function.

The object of a control function in two degrees of freedom, which comprises on the one hand a feedforward control component 55 with a state controller 55A, a control variable limiter 55B and a controller model 55C and on the other hand a PID controller component 57 with a PID controller 57A and a control variable limiter 57B, is to position the actuator and hence the suspension point 58 of the elastic coupling element on the gearbox side by means of suitable control signals such that a spring tension resulting from the force profile is achieved. The desired spring tension can be built up within for example 10 to 40 ms in the case of a suitable actuator resilience. The desired spring tension is built up as a result of an angular separation being changed between the suspension point 58 on the gearbox side and the suspension point 54 of the elastic coupling element 9 on the pedal side.

The pedal system can comprise three position sensors: a sensor for detecting the angular position a of the actuator, a further sensor for detecting the angular position β′ of the actuating element 27 or the position of the driving element 31 on the actuating element 27, and a further sensor for detecting the angular position β of the pedal lever 5. In one exemplary embodiment, at least two position sensors are necessary, a first sensor for detecting the angular position of the pedal lever 5 and a second sensor for detecting the angular position of the suspension point 58 on the gearbox side. Said position sensors can for example be Hall sensors. A proportionality ratio can also be defined between the angular position β of the pedal lever and the angular position of the actuating element, i.e. so that the actuating element 27 is coupled to the pedal lever 5 by means of the driving element 31 such that the actuating element is driven correspondingly during a displacement of the pedal lever. Alternatively, the pedal system can also be implemented such that the actuating element is not driven during a displacement of the pedal lever in the direction of the vehicle driver.

By using the control arrangement described, a coupling spring with low stiffness can achieve high forces in a short time, because the spring travel of the elastic coupling element 9 is used as a control variable. This can be viewed as the main task of the control function. For a pedal system according to the invention, it is seen as advantageous to provide a coupling spring of low stiffness, very fast control and an actuator with fast actuating behavior. A desired force profile can be transmitted almost unaltered in magnitude and dynamics owing to the interaction of said three factors. The coupling spring apparently increases in “stiffness”, i.e. this is achieved owing to fast control and a rapid actuator. At the same time the significant damping properties of the low stiffness coupling spring are used. Torque fluctuations (ripple-torque) of the actuator motor can be suppressed and the pedal can be operated almost decoupled from the actuator. Disturbance moments of inertia from the actuator are thus hardly perceptible on the pedal lever.

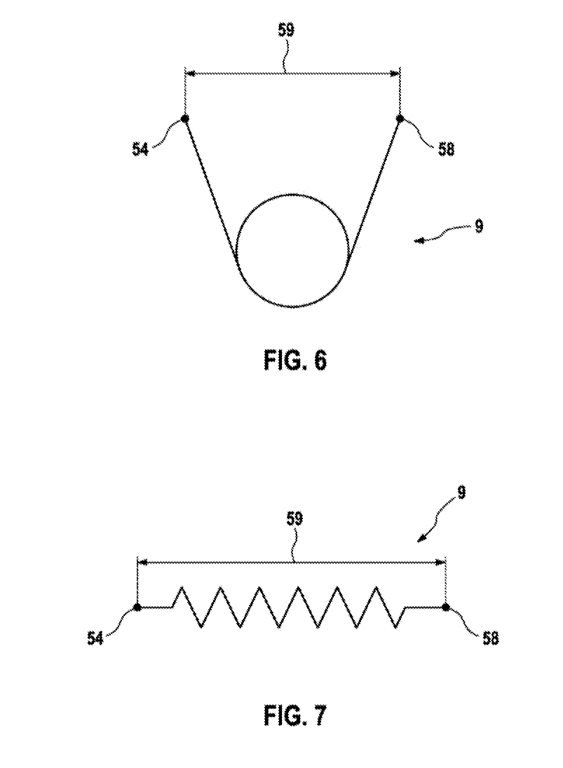

FIG. 6 shows an elastic coupling element 9 in the form of a coil spring, both suspension points 54, 58 of which are spaced apart from each other by the spring travel/angle 59. The spring stiffness of the coil spring acts during this so that the suspension points 54, 58 can only be moved towards each other by applying an external force. In the pedal system as described above, the spring travel/angle 59 between the suspension points 54, 58, which can be viewed as the relative angular position between the suspension point on the gearbox side and the suspension point on the pedal side, thus constitutes the control variable for the control of the actuator. Said spring travel can for example be determined from the values of the pedal lever position sensor and of the actuator position sensor. In this case the first suspension point 54 is the suspension point 54 on the pedal side and the second suspension point 58 is the suspension point 58 on the gearbox side. The suspension points 54, 58 are formed by the two spring arms of the coil spring. The relative position of the spring arms to each other is varied by varying the twist angle or opening angle of the coil spring, whereby the spring travel/angle 59 also changes, so that a force exerted by the coil spring can be adjusted as a result.

FIG. 7 shows, alternatively to FIG. 6, a compression spring in the form of a spiral spring. The suspension points 54, 58, and thus the spring travel/angle 59 that is relevant to the control, are spaced apart from each other in the longitudinal direction of the spring by the distance 59. Both in FIG. 6 and also in FIG. 7 the spring travel/angle 59, i.e. the control variable of the actuator of the pedal system, extends in the direction in which the suspension points 54, 58 are forced away from each other by the spring stiffness.

1. A pedal system for a motor vehicle, comprising:
a pedal lever configured to be displaced in response to a force exerted by a driver;
an actuator configured to produce a restoring force on the pedal lever;
a control unit configured to control the actuator; and
an elastic coupling element that is operatively disposed between the pedal lever and the actuator such that the restoring force produced by the actuator is at least partly transferred to the pedal lever via the elastic coupling element;
wherein a spring travel of the elastic coupling element in the direction of the force exerted on the pedal lever is used as a control variable for controlling the actuator.

2. The pedal system as claimed in claim 1, wherein the elastic coupling element is configured to damp oscillations produced by the actuator with frequencies of more than 8 Hz.

3. The pedal system as claimed in claim 1, wherein the elastic coupling element includes a spring.

4. The pedal system as claimed in claim 1, wherein the elastic coupling element includes a coil spring.

5. The pedal system as claimed in claim 1, further comprising:
a pedal lever position sensor configured to detect a current position φₚ of the pedal lever; and
an actuator position sensor configured to detect a current position φₐ of the actuator;
wherein the current position φₚ of the pedal lever and the current position φₐ of the actuator define the spring travel of the elastic coupling element.

6. A method for controlling an actuator of a pedal system, comprising:
determining a current position φₚ of a pedal lever configured so as to be displaceable within a displacement region along an actuation direction between a rest position and a maximally activated position;
determining a current position φₐ of an actuator configured to produce counter force opposite to the actuation direction;
determining a current spring travel of an elastic coupling element from the current position φₚ of the pedal lever as well as the current position φₐ of the actuator, the elastic coupling element operatively disposed between the pedal lever and the actuator such that the counter force produced by the actuator is at least partly transferred to the pedal lever via the elastic coupling element; and
controlling the actuator to exert a counter force on the pedal lever via the elastic coupling element, the exerted counter force having a predetermined force profile configured to produce a haptically perceptible signal;
wherein the spring travel of the elastic coupling element is a control variable for controlling the actuator.

7. The method as claimed in claim 6, wherein a position φₐ of the actuator is controlled with reference to a 2-degrees of freedom control function.

8. A control unit for controlling a pedal system in a motor vehicle, wherein the control unit is configured to:
determine a current position φₚ of a pedal lever configured so as to be displaceable within a displacement region along an actuation direction between a rest position and a maximally activated position;
determine a current position φₐ of an actuator configured to produce counter force opposite to the actuation direction;
determine a current spring travel of an elastic coupling element from the current position φₚ of the pedal lever as well as the current position φₐ of the actuator, the elastic coupling element operatively disposed between the pedal lever and the actuator such that the counter force produced by the actuator is at least partly transferred to the pedal lever via the elastic coupling element; and
control the actuator to exert a counter force on the pedal lever via the elastic coupling element, the exerted counter force having a predetermined force profile configured to produce a haptically perceptible signal;
wherein the spring travel of the elastic coupling element is a control variable for controlling the actuator.

9. The control unit as claimed in claim 8, comprising:
a data input configured to receive data that define the current position φₚ of the pedal lever;
a data input configured to receive data that define the current position φₐ of the actuator;
an optimal value controller; and
a PID controller.

10. The control unit as claimed in claim 8, further configured to operate according to computer-readable instructions.

11. The control unit as claimed in claim 10, further comprising:
a computer-readable medium, the computer-readable instructions stored thereon.
